(19) United States
(12) Patent Application Publication
(10) Pub. No.: US 2009/0226866 A1
(43) Pub. Date: Sep. 10, 2009

(54) SURGICAL TEACHING AID

(76) Inventor: Harold Durbin, Louisville, NE (US)

Correspondence Address: SUITER SWANTZ PC LLO, 14301 FNB PARKWAY, SUITE 220, OMAHA, NE, 68154, US

(21) Appl. No.: 12/400,257

(22) Filed: Mar. 9, 2009

Related U.S. Application Data
(60) Provisional application No. 61/068,606, filed on Mar. 7, 2008.

(51) Int. Cl. G09B 23/30; B23P 17/04

(52) U.S. Cl. 434/267; 29/428

(57) ABSTRACT

A surgical teaching aid may comprise: a) a cast of a body part; and b) a flexible member disposed within the cast.

A mold for a surgical teaching aid may comprise: a) a mold of a body part; and b) one or more flexible members disposed within the mold and operably coupled to the mold of a body part.

A method for manufacturing a surgical teaching aid may comprise: a) disposing a flexible member within a mold of a body part; and b) disposing a hardenable composition within the mold.

### CROSS REFERENCE TO RELATED APPLICATIONS

The present application claims the benefit under 35 USC § 119(e) of U.S. Patent Provisional Application Ser. No. 61/068,606, filed Mar. 7, 2008, which is incorporated herein by reference to the extent such subject matter is not inconsistent herewith.

### BACKGROUND

Endoscopic vein harvest (EVH) and endoscopic radial harvest (ERH), (hereinafter collectively “EVH”) may be required prior to coronary artery bypass and vascular surgeries.

EVH is a minimally invasive technique to obtain both vein and artery conduit prior to coronary artery and vascular surgeries. However, the associated skills required for proficiency in such procedures may only be obtained through repeated practice sessions. Most practitioners require between 50-100 sessions to become comfortable, let alone proficient, with such techniques. To date, the only available teaching tools have been cadaver extremities or computer-based Virtual Reality (VR) models.

The use of cadaver extremities has several drawbacks. First is the availability of usable specimens. Since available in only limited supply, teaching sessions have required limitation to only one or two extremities per practitioner. Additionally, the cost of each extremity is several hundred dollars each. Further adding to the expense of each session is the cost of transport and the regulations and cost associate with disposal of bio-hazardous waste.

The difficulty associated with the VR computer based models is the massive expense of development of such a product. Development of this type of technology has been in the millions of dollars, which does not include ongoing updates and maintenance necessary to assure uninterrupted usage. Additionally, the VR systems lack the tactile sense and response of human tissue required to provide meaningful practice experiences.

As such, it is desirable to provide an instructional model for EVH which provides realistic tactile interactions without the use of human tissue.

### SUMMARY OF THE INVENTION

A surgical teaching aid may comprise: a) a cast of a body part; and b) a flexible member disposed within the cast.

A method for manufacturing a surgical teaching aid may comprise: a) creating a mold of a body part; b) disposing a flexible member within the mold; c) removably coupling the flexible member to the mold; and d) disposing a moldable composition within the mold.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 shows a front perspective view of a mold for a surgical teaching aid.

FIG. 2 shows a side perspective view of a surgical teaching aid disposed within a mold for the surgical teaching aid.

FIG. 3 shows a cross-sectional view of a surgical teaching aid disposed within a mold for the surgical teaching aid.

FIG. 4 shows an exploded view of a surgical teaching aid and a mold for a surgical teaching aid.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

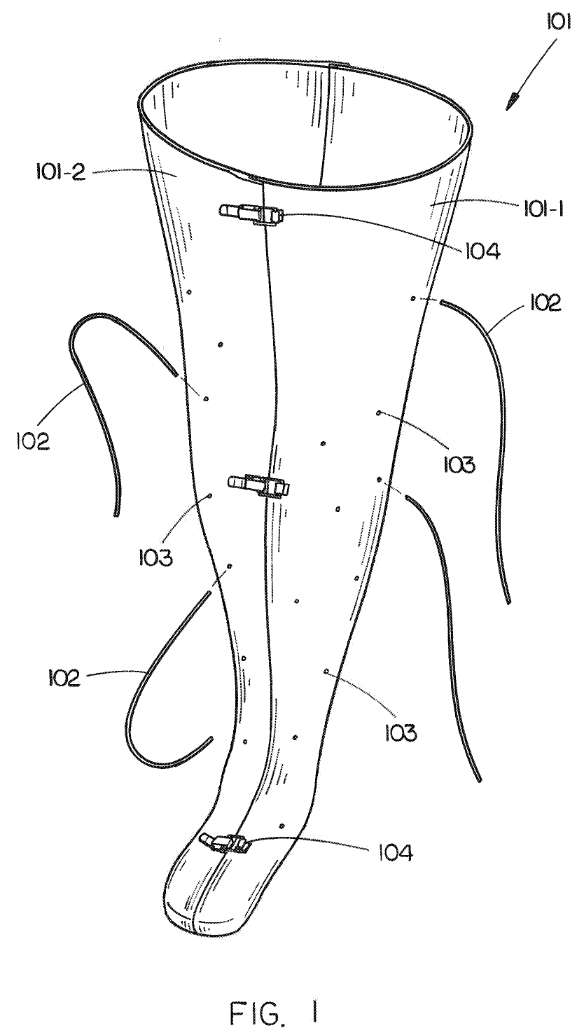

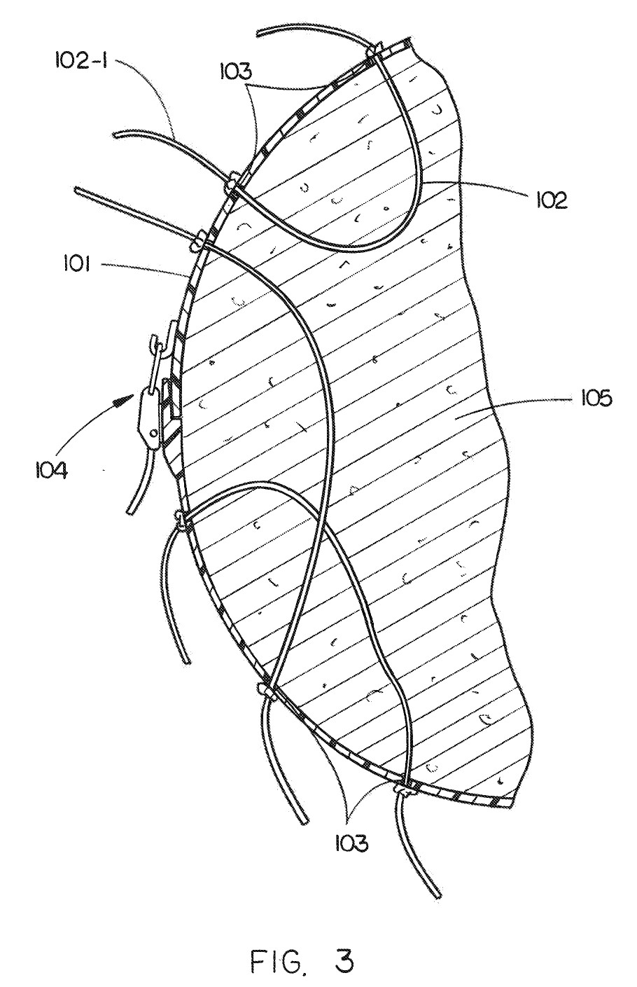

Referring to FIGS. 1-4, a various views of a mold 101 of an extremity for creating a surgical teaching aid 105 are presented. In the depicted embodiments, the mold is that of a human leg. However, the mold may be constructed for any body part (e.g. arm, torso, etc.) of any human or animal without departing from the scope of the present disclosures.

Referring to FIG. 1, a synthetic replica of a vein or artery (collectively synthetic vasculature 102) may be suspended within the mold 101 at a desired anatomical position with respect to the mold 101. The mold 101 may include one or more apertures 103. The synthetic vasculature 102 may be routed through the apertures 103 in order to replicate the routing of actual vasculature within a body part. Alternatively, the synthetic vasculature 102 may be affixed to an interior surface of the mold 101 by any releasable mechanism including, but not limited to, clips, snaps, hooks, Velcro, and the like.

The synthetic vasculature 102 may be constructed of flexible latex tubing having a diameter (e.g. 10 mm) and consistency similar to that of actual vasculature structures.

The mold 101 may be constructed by casting a human leg or arm, using human model in a standard plaster-casting wrap as a pre-mold. After hardening, the pre-mold may be removed and filled with plaster and water solution to make a cast of the leg. After hardening, the pre-mold may be removed and the leg cast rasped to shape. While the example above describes the use of plaster compositions in the creation of the leg cast, any mechanism for the creation of a substantially life-size model of an extremity (e.g. injection molding) may be used without departing from the scope of the invention.

The leg cast may be covered to provide a non-stick barrier (e.g. covering with a nylon stocking) to prevent adhesion of a mold material (e.g. a plastic sheet such as polyethylene, polyethylene terephthalate, polypropylene, polyvinylchloride, etc.) to the leg cast.

For example, a ⅛ inch thick plastic sheet may be cut to size and length according to the size of the leg cast and heated in an oven (e.g. at approximately 350 degrees F.) to enhance pliability. While the plastic is pliable, it may be wrapped around the leg cast and a vacuum of from about 10-15 psi applied under the plastic sheet to maintain the heated plastic in position around the leg cast during cooling. The completed plastic mold 101 may then be removed from around the leg cast. While the example above describes the use of an plastic wrap disposed around an extremity cast, any mechanism for the creation of a substantially life-size mold of an extremity (e.g. extrusion blow molding, injection blow molding, and stretch blow molding) may be used without departing from the scope of the invention.

Cylindrical latex rubber may be stretched and shaped to form the synthetic vasculature 102 in order represent a vascular vessel to be removed during a teaching session. The synthetic vasculature 102 may be removably attached to the mold 101 in the particular anatomical configuration of the desired vascular vessel. For example, the mold 101 may be drilled to form apertures 103. The synthetic vasculature 102 may be placed in the anatomical configuration with one or more branches of the synthetic vasculature 102 routed through apertures 103 of the mold 101 to support the synthetic vasculature 102 in place.

In a particular embodiment, the mold 101 may include one or more portions having edges that may be operably coupled by a coupling mechanism. For example, the mold may include a first mold portion 101-1 and a second mold portion 101-1. The first mold portion 101-1 and the second mold portion 101-1 may be coupled by at least one buckle 104. At least a portion of the first mold portion 101-1 and the second mold portion 101-1 may be in an overlapped configurations when the first mold portion 101-1 and the second mold portion 101-1 are operably coupled so as to at least partially seal the mold 101 and permit the mold 101 to retain fluid.

Additionally, the seams between formed by the first mold portion 101-1 and the second mold portion 101-1 and the apertures 103 may be sealed with a sealant (e.g. a polyurethane sealant) so as to further seal the mold 101 and permit the mold 101 to retain fluid.

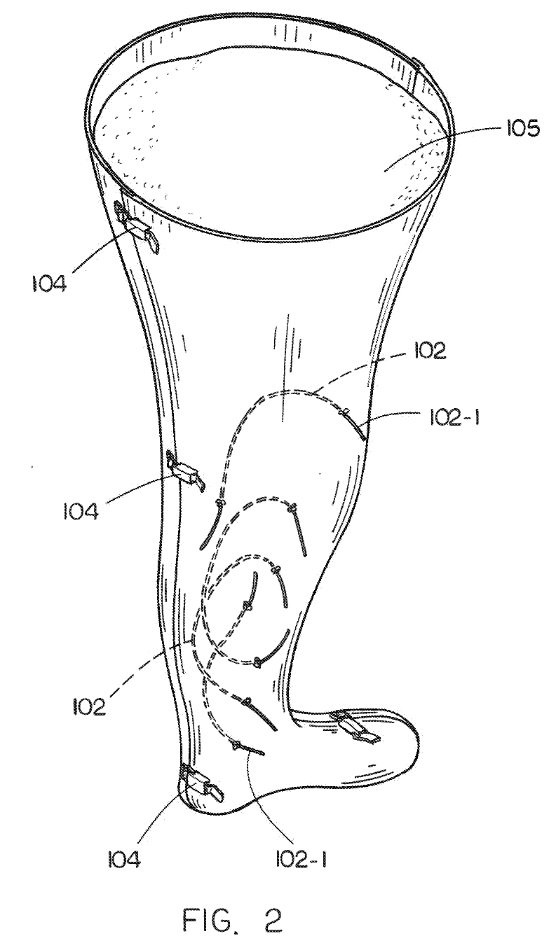

Referring to FIGS. 2-4, a surgical teaching aid 105 including the synthetic vasculature 102 may be constructed by disposing an amount of a hardenable composition (e.g. a fluid or gel composition which may cure to form a semi-solid or solid product) within the mold 101. For example, a heated gelatin solution (e.g. a solution of 2.5 gallons of water heated and combined with 4 lbs of food grade gelatin or about a 20% by weight concentration) may be mixed and allowed to partially cool. The gelatin solution, once cooled, may be poured into the mold 101 and allowed to solidify.

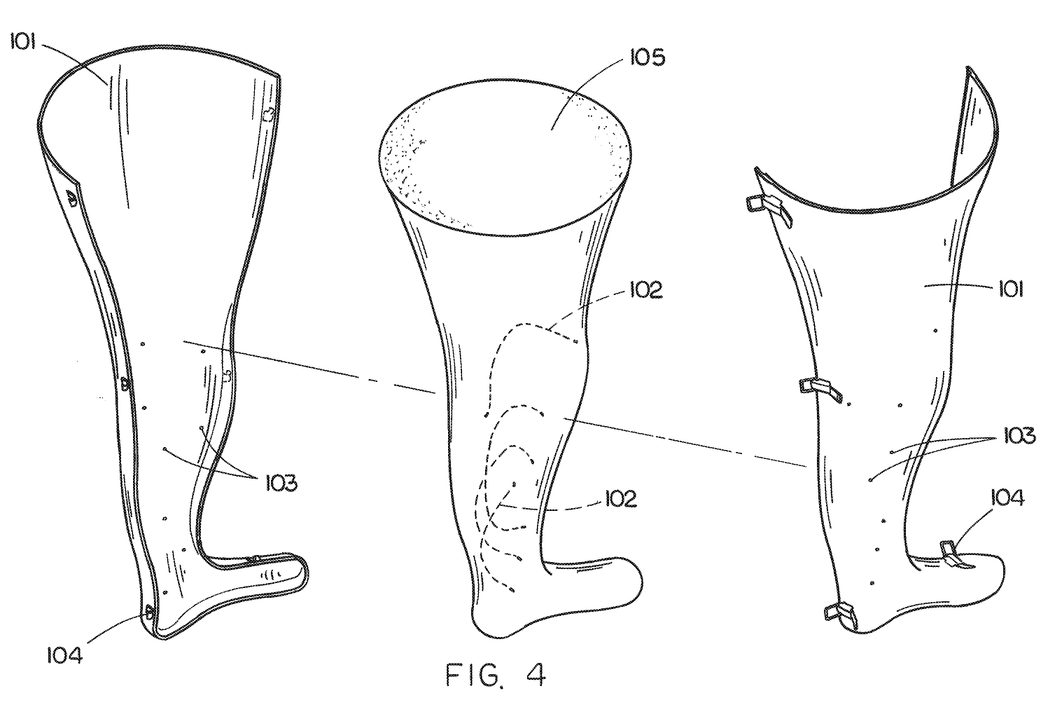

Referring to FIG. 4, once the hardenable composition has solidified, the mold 101 may be removed. In the case where the synthetic vasculature 102 has been routed through the apertures 103, any portions of the synthetic vasculature 102 (e.g. synthetic vasculature 102-1) extending outside the enclosed portion of the mold 101 may be trimmed away so as to facilitate the removal of the mold 101 from the formed surgical teaching aid 105.

The working surgical teaching aid 105 may be used in either its semi-transparent form directly from the mold for direct visualization, or may be covered with flesh tone outer wrap (a flat sheet of flesh colored latex rubber) to simulate the skin layer during advanced training sessions.

Used gelatin may be ground and reconstituted for use again, thereby reducing the overall cost of each extremity.

It is believed that the system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. A surgical teaching aid comprising:
a cast of a body part;
one or more flexible members disposed within the cast.

2. The surgical teaching aid of claim 1, wherein the cast of a body part comprises:
an at least partially solidified composition comprising a 20% by weight aqueous solution of food grade gelatin.

3. The surgical teaching aid of claim 1, wherein the one or more flexible members disposed within the cast is configured to replicate one or more vascular structures associated with the body part.

4. The surgical teaching aid of claim 1, wherein the one or more flexible members disposed within the cast comprises:
latex tubing.

5. A mold for a surgical teaching aid comprising:
a mold of a body part;
one or more flexible members disposed within the mold and operably coupled to the mold.

6. The mold of claim 5, wherein the mold of a body part further comprises:
one or more apertures.

7. The mold of claim 6, wherein at least one of the one or more flexible members is disposed within at least one of the one or more apertures.

8. The mold of claim 5, wherein the mold of a body part comprises at least a first portion operably couplable to a second portion.

9. The mold of claim 5, wherein the one or more flexible members comprises:
latex tubing.

10. The mold of claim 5, wherein the one or more flexible members is configured to replicate a position of at least one vascular structure of the body part.

11. A method for manufacturing a surgical teaching aid comprising:
disposing a flexible member within a mold of a body part;
disposing a hardenable composition within the mold.

12. The method of claim 11, wherein the disposing a flexible member within a mold of a body part comprises:
configuring the flexible member to replicate a position of at least one vascular structure of the body part.

13. The method of claim 12, wherein disposing a hardenable composition within the mold comprises:
disposing a 20% by weight aqueous solution of food grade gelatin within the mold.
